(19) United States
(12) Patent Application Publication
(10) Pub. No.: US 2010/0309198 A1
(43) Pub. Date: Dec. 9, 2010

(54) METHOD FOR TRACKING 3D ANATOMICAL AND PATHOLOGICAL CHANGES IN TUBULAR-SHAPED ANATOMICAL STRUCTURES

(76) Inventor: Claude Kauffmann, Montreal (CA)

Correspondence Address: GOUDREAU GAGE DUBUC, 2000 MCGILL COLLEGE, SUITE 2200, MONTREAL, QC, H3A 3H3, CA

(21) Appl. No.: 12/600,134

(22) PCT Filed: May 15, 2008
(86) PCT No.: PCT/CA2008/000933

§ 371 Date: Nov. 13, 2009

Related U.S. Application Data
(60) Provisional application No. 60/938,078, filed on May 15, 2007.

(51) Int. Cl. G06K 9/00; G06T 15/00

(52) U.S. Cl. 345/419; 382/128; 382/131

(57) ABSTRACT

A method for visualizing the anatomy of a region of interest of a tubular-shaped organ based on acquired three-dimensional image slices of the region of interest. Prior to segmentation, reference markers are positioned interactively in the image slices, a minimum curvature path connecting the reference markers is automatically extracted and cross-sectional images are interpolated along a plane normal to a tangent vector of the minimum curvature path. A segmented area corresponding to the region of interest is then delimited in each cross-sectional image and, using this segmented area, a three-dimensional surface representation of the region of interest is computed to readily quantify attributes, such as a maximal diameter and a volume, of the region of interest. When the image sets are acquired in different imaging geometries, the image sets may further be co-registered prior to segmentation, resulting in image sets superimposed in the same geometrical reference frame.

### CROSS REFERENCE TO RELATED APPLICATIONS

This application claims priority on U.S. Provisional Application No. 60/938,078, filed on May 15, 2007 and which is herein incorporated by reference in its entirety.

### FIELD OF THE INVENTION

The present invention relates to a method for tracking 3D anatomical and pathological changes in tubular-shaped anatomical structures.

### BACKGROUND OF THE INVENTION

Medical imaging is increasingly used to study the changes in size and shape of anatomical structures over time. As these changes often serve as indicators of the presence of a disease, extraction of quantitative information from such medical images has many applications in clinical diagnosis.

Conventional practice is to outline anatomical structures by image segmentation, a fundamental step of image analysis, during which anatomical and pathological structure information is typically extracted from patient image data. Image segmentation allows various relevant anatomical structures to be distinguished, which often have similar intensity values on the image and thus overlap or are interrelated. Performing the segmentation directly in the three-dimensional (3D) space brings more consistency in the results. The method enables clinicians to emphasize and extract various features in the digital images by partitioning them into multiple regions, thereby delimiting image areas representing objects of interest, such as organs, bones, and different tissue types. Although different segmentation approaches have been applied in different situations, the common principle lies in the iterative process, which progressively improves the resulting segmentation so that it gradually corresponds better to a certain a priori image interpretation. Still, currently practiced methods take a significant amount of time to extract information from the medical images, and as a result do not achieve optimal results in a fast and efficient manner.

Medical imaging has proven particularly effective in the diagnosis of pathologies such as aortic aneurysms, a fairly common disorder characterized by a localized dilation greater than 1.5 times the typical diameter of the aorta. As rupture of the aneurysm, which is the main complication of the disorder, typically results in death due to internal bleeding, accurate diagnosis and control of the aneurysm are critical. The main predictors of rupture risk are the maximal diameter (Dₘₐₓ) and the expansion rate of the aneurysm. It has been suggested that a Dₘₐₓ value greater than 5.5 cm in men and 4.5 to 5.0 cm in women, as well as an expansion rate greater than 1 cm per year are indications for a procedure. Study of these parameters is therefore crucial in determining when a surgical intervention is warranted to prevent the aneurysm from rupturing or causing other complications in the future.

The prior art teaches various methods for computing the value of Dₘₐₓ, leading to different inconsistent definitions of the Dₘₐₓ parameter. In addition, current measurement methods typically generate intra- and inter-observer variability as well as result in systematic overestimation of the Dₘₐₓ value as they use either rough estimation based on the appearance of the aneurysm or cumbersome and time-consuming manual outlining of aneurysm anatomy or pathology on sequences of patient images. Also, as current segmentation techniques use contrast agents that only enable visualization of the aneurysm lumen and not visualization of the thrombus, the latter cannot be segmented using these methods, although it is critical in determining the value of Dₘₐₓ. Current segmentation techniques further make it difficult to control the quality of the segmentation as well as correct any mistakes generated by the software.

What is therefore needed, and an object of the present invention, is a standardized method for tracking 3D changes in an anatomical structure, such as an aortic aneurysm, based on 3D images. In particular, a clinical diagnostic tool, which enables segmentation of medical images in 3D to be performed and accurate information related to the anatomical structure under observation obtained in a simple, fast and reproducible manner, would be useful.

### SUMMARY OF THE INVENTION

In order to address the above and other drawbacks, there is disclosed a method for visualizing an anatomy of a region of interest of a tubular-shaped organ on a display. The method comprises acquiring an image of the anatomy of the tubular shaped organ in the region of interest at a first point in time, extracting a plurality of discrete points from the image defining a minimum-curvature path within the tubular-shaped organ, interpolating a set of cross-sectional images along planes substantially perpendicular to a tangent vector of the minimum-curvature path at each of the plurality of discrete points, delimiting a segmented area corresponding to the region of interest of the tubular-shaped organ in each of the set of cross-sectional images, rendering a three-dimensional surface representation of the region of interest from the delimited set of cross-sectional images and displaying the rendered three-dimensional surface representation on the display.

There is also disclosed a method for visualizing the anatomy of a region of interest of a tubular-shaped organ. The method comprises acquiring at least a first image and a second image of the anatomy of the tubular shaped organ in the region of interest, the first image and the second image having different imaging geometries, computing similarity criteria between the first image and the second image, deriving at least one geometrical transformation parameter from the similarity criteria, co-registering the first image and the second image according to the at least one geometrical transformation parameter, extracting a plurality of discrete points from the co-registered first and second images, the points defining a minimum-curvature path within the tubular-shaped organ, interpolating cross-sectional images from the co-registered first and second images along planes substantially perpendicular to a tangent vector of the minimum-curvature path at the plurality of discrete points, delimiting a segmented area corresponding to the region of interest of the tubular-shaped organ in each of the cross-sectional images, computing a three-dimensional surface representation of the region of interest from the segmented area and quantifying attributes of the region of interest from the three-dimensional surface representation.

Additionally, there is disclosed a system for visualizing the anatomy of a region of interest of a tubular-shaped organ. The system comprises a scanning device for acquiring an image of the region of interest of the tubular shaped organ, a database connected to the scanning device for storing the acquired image, and a workstation connected to the database for retrieving the stored image, the workstation comprising a display, a user interface, and an image processor. Responsive to the commands from the user interface, the image processor extracts from the image a plurality of discrete points defining a minimum-curvature path within the region of interest of the tubular-shaped organ, interpolates a set of cross-sectional images along planes substantially perpendicular to a tangent vector of the minimum-curvature path at each of the plurality of discrete points, delimits a segmented area corresponding to the region of interest of the tubular-shaped organ in each of the set of cross-sectional images, computes a three-dimensional surface representation of the region of interest from the delimited set of cross-sectional images and displays the computed three-dimensional surface representation on the display.

Furthermore, there is disclosed a computer program storage medium readable by a computing system and encoding a computer program of instructions for executing a computer process for visualizing the anatomy of a region of interest of a tubular-shaped organ. The computer process comprises acquiring an image of the anatomy of the tubular shaped organ in the region of interest, extracting from the image a plurality of discrete points defining a minimum-curvature path within the tubular-shaped organ, interpolating a set of cross-sectional images along planes substantially perpendicular to a tangent vector of the minimum-curvature path at each of the discrete points, delimiting a segmented area corresponding to the region of interest of the tubular-shaped organ in each of the set of cross-sectional images, computing a three-dimensional surface representation of the region of interest from the delimited set of cross-sectional images, and displaying the rendered three-dimensional surface representation on the display.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a schematic diagram of an image analysis system in accordance with an illustrative embodiment of the present invention;

FIG. 2 is a flow chart of an image analysis method in accordance with an illustrative embodiment of the present invention;

FIG. 3 is a diagram of an abdominal aortic aneurysm in accordance with an illustrative embodiment of the present invention;

FIGS. 4a and 4b show cross-section images of the abdominal aortic aneurysm of FIG. 3 during landmark initialization in accordance with an illustrative embodiment of the present invention;

FIG. 5 shows a cross-section image of an abdominal aortic aneurysm interpolated along a minimum-curvature path in accordance with an illustrative embodiment of the present invention;

FIGS. 6a and 6b show a representation of cross-section images used for segmentation of an abdominal aortic aneurysm in accordance with an illustrative embodiment of the present invention;

FIGS. 7a and 7b show the cross-section images of FIGS. 6a and 6b during positioning of angular slices in accordance with an illustrative embodiment of the present invention;

FIGS. 8a and 8b show cross-section images of an abdominal aortic aneurysm during active-shape contour segmentation in accordance with an illustrative embodiment of the present invention;

FIGS. 9a and 9b show cross-section images of an abdominal aortic aneurysm during segmentation quality control in accordance with an illustrative embodiment of the present invention;

FIG. 10 is a schematic diagram of a 3D aneurysm wall model in accordance with an illustrative embodiment of the present invention;

FIG. 11 is a representation of the 3D aneurysm wall model of FIG. 10 in axial, sagittal and coronal views in accordance with an illustrative embodiment of the present invention;

FIGS. 12a and 12b show two representations of the maximum diameter of an abdominal aortic aneurysm in accordance with an illustrative embodiment of the present invention;

FIG. 13a shows a segmentation of the false thrombus an aorta in accordance with an illustrative embodiment of the present invention;

FIG. 13b shows a segmentation of an aorta separated into two pathological components resulting from aortic dissection in accordance with an illustrative embodiment of the present invention;

FIG. 14a shows a segmentation of the lumen of a thoracic aortic aneurysm in accordance with an illustrative embodiment of the present invention;

FIGS. 14b and 14c show a segmentation of the thrombus and a representation on a 3D wall model of the maximum diameter of a thoracic aortic aneurysm in accordance with an illustrative embodiment of the present invention;

FIGS. 14d and 14e show a representation on a 3D wall model of the thrombus thickness of a thoracic aortic aneurysm in accordance with an illustrative embodiment of the present invention;

FIG. 15 shows a segmentation of a cat's spinal cord in accordance with an illustrative embodiment of the present invention;

FIG. 16 is a flow chart of an image registration method in accordance with an illustrative embodiment of the present invention; and

FIG. 17 is a schematic of an abdominal aortic aneurysm during landmark initialization for image registration in accordance with an illustrative embodiment of the present invention.

### DETAILED DESCRIPTION OF THE ILLUSTRATIVE EMBODIMENTS

The present invention is illustrated in further details by the following non-limiting examples.

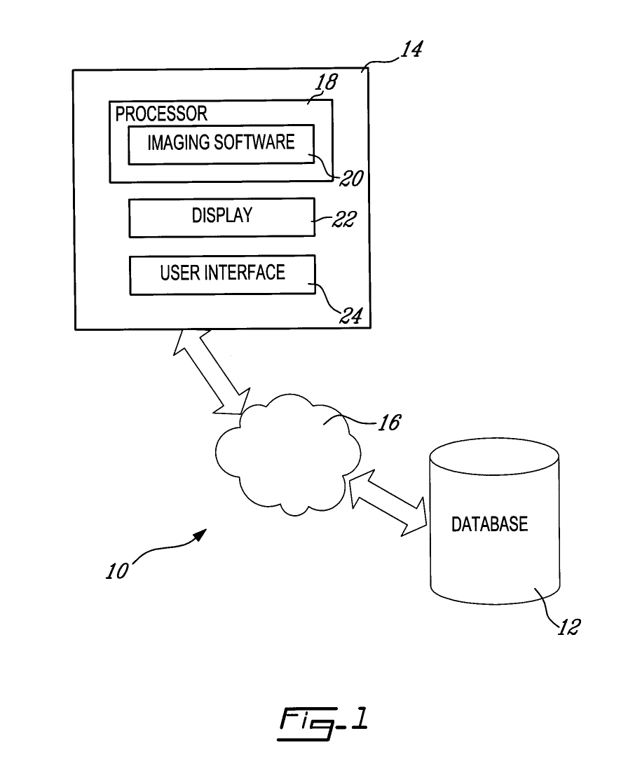

Referring to FIG. 1, and in accordance with an illustrative embodiment of the present invention, a system for processing and analyzing medical images, generally referred to using the reference numeral 10, will now be described. The system 10 comprises a database 12 for storing patient images and a workstation 14 for accessing the stored images through a communications network 16, such as a Local Area Network (LAN). The workstation 14 comprises a processor 18, on which an imaging software module 20 responsible for processing images retrieved from the database 12 is installed. The workstation 14 further comprises a display 22 and a user interface 24 (e.g. a mouse and keyboard), which enable users to interact with the imaging software 20 by displaying and manipulating image data in response to input commands. The display 22 and the user interface 24 thus enable users to visualize and supervise the image analysis process performed by the imaging software 20.

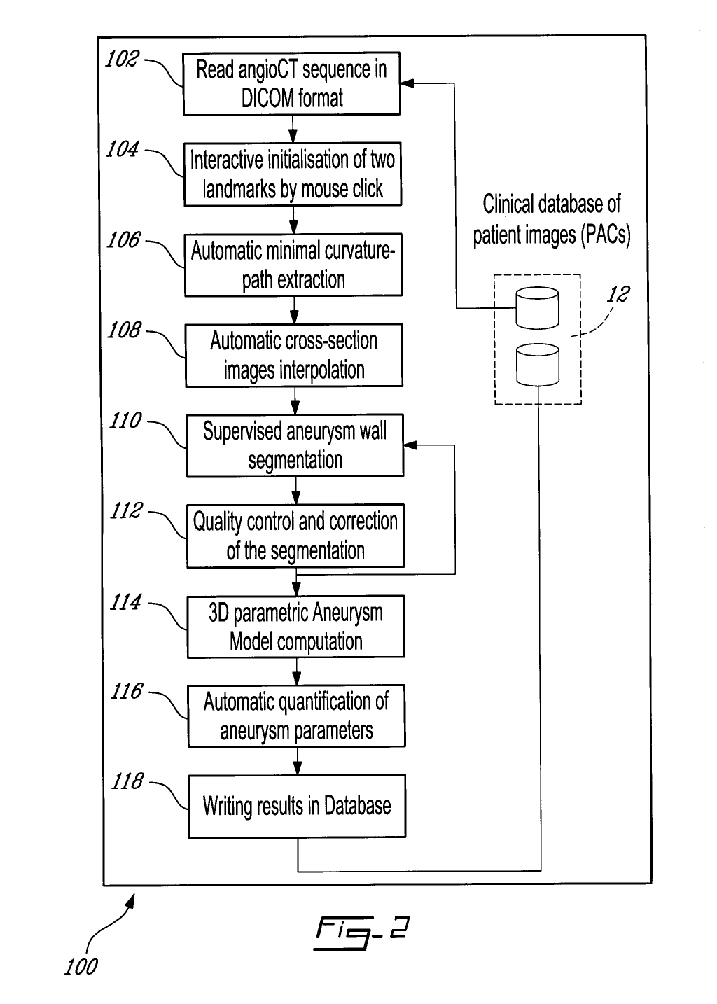

Referring now to FIG. 2 in addition to FIG. 1, a medical image analysis method 100 implemented by the imaging software 20 will now be described. Clinical image data related to a patient under observation is typically acquired by a scanner (not shown) of a standard medical imaging modality such as Computed Tomography (CT) or Magnetic Resonance Imaging (MRI) angiography. Angiography has the advantage of being an efficient and relatively non-invasive diagnostic tool. Illustratively, in CT angiography, an X-ray picture is taken to visualize the inner opening of blood filled structures, including arteries, veins and the heart chambers. Contrast agents may be used to improve the visibility of the patient's internal bodily structures on the angiography image, for instance by enabling to differentiate intensity values of the vessel interior and wall. Thin axial image slices of the area under observation are typically obtained during the procedure and images in the remaining two spatial planes (coronal and sagittal) are calculated by a computer. After their acquisition, the patient images are stored as image data sets into the database 12, illustratively in the Digital Image Communications in Medicine (DICOM) format, for subsequent retrieval and analysis. DICOM format is of particular interest in medical applications, as it enables easy standardised data communication between systems produced by different manufacturers and using different internal formats, thus allowing effective connection of different components of an imaging department. Since different clinical imaging exams may be performed at different times to study the progression of a patient's disorder, a resulting plurality of image data sets corresponding to each imaging exam may be stored in the database 12 and each image set is then treated separately by the imaging software 20.

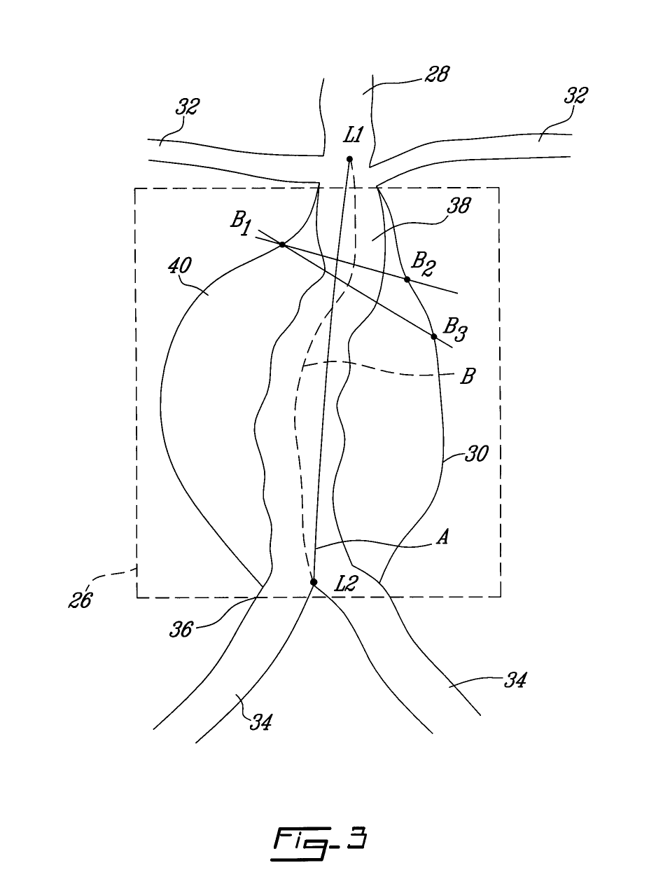

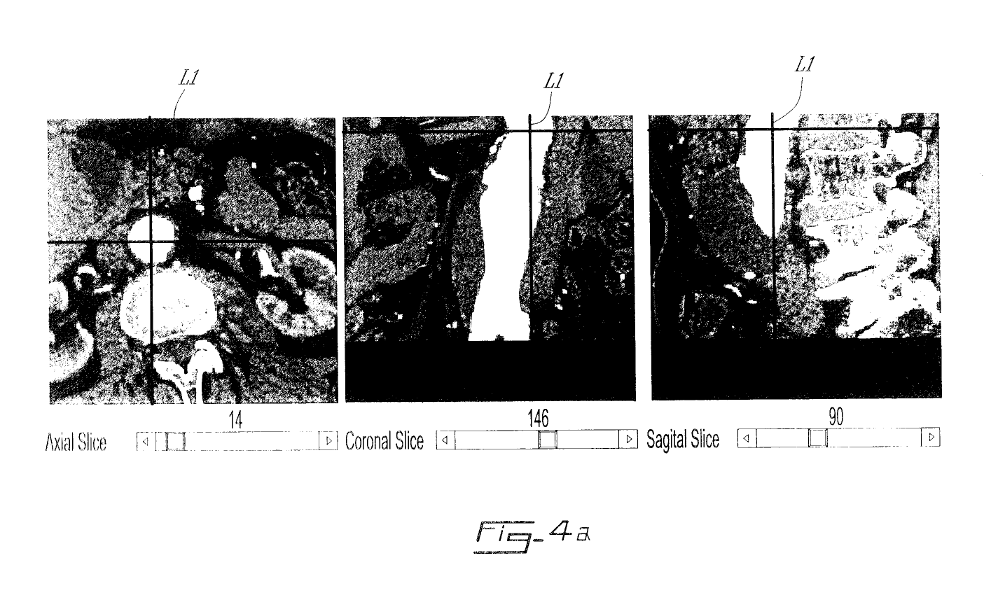

Referring now to FIG. 3 and FIGS. 4a and 4b in addition to FIGS. 1 and 2, a user wishing to analyze patient images illustratively accesses the workstation 14, and via the user interface 24 (which illustratively comprises, in addition to the display 22, a pointing device such as a mouse or the like and an appropriate operating system software), imports the image set(s) related to the patient under observation. The imaging software 20 is then invoked by the user in order to open the imported images (102), which are shown on the display 22 so that the user may proceed with the segmentation process at 104. For sake of illustration, the anatomical structure under observation is an abdominal aortic aneurysm 26, although it would be understood by one skilled in the art that the method 100 may be applied to other types of aneurysms (e.g. thoracic, intracranial), as well as other tubular-shaped organs, such as the colon, trachea, and spine. The method 100 may also have other applications such as analysis of soft tissues, of atheromatous plaque in carotid arteries, and follow-up of stent grafts.

As illustrated in FIG. 3, an abdominal aortic aneurysm 26 is a disorder of the aorta 28 characterized by a localized dilation of the arterial wall 30. An aortic aneurysm is typically located below the renal arteries 32 and above the iliac arteries 34 and the aorta-iliac bifurcation 36. The inner space of the aorta is referred to as the lumen 38, as is the case for any other vessel in the body, while the thickness of the aorta wall in the region of the aneurysm is referred to as the thrombus 40.

Still referring to FIG. 3, FIG. 4a and FIG. 4b in addition to FIG. 2, to visualize the aneurysm 26 and initiate the segmentation process of the aneurysm wall 30, the user illustratively defines two displaced landmarks L1 and L2 in characteristic and easily identifiable regions of the lumen 38 and towards either ends of the portion of the lumen 38 to be visualised. This is done via the user interface 24 by moving a cursor in one or other of the displayed axial, coronal and sagittal image slices, as illustrated in FIG. 3. Illustratively, a first landmark Ll is placed before the aneurysm 26 (FIG. 4a) and a second landmark L2 after the aneurysm 26 (FIG. 4b). The user then validates the positions of the landmarks, for example by simple mouse click. Landmark initialization is illustratively done in Multi-Planar Reformatting (MPR) view, a reformatting technique which passes a plane through an image set, thus enabling users to view the volume under inspection along a different direction than that of the original image set. In effect, one can view the image data from different viewpoints without having to rescan the patient.

Still referring to FIG. 3, FIG. 4a and FIG. 4b in addition to FIG. 2, the landmarks L1 and L2 thus defined are used at 106 as start and end points for automatic extraction of a minimum-curvature path A (not necessarily straight). It is desirable for the path A, which links landmarks L1 and L2 and has minimal curvature, to be fully defined inside the aneurysm lumen 38. The path A is used to define new cross-section images, which ensure that slicing of the aneurysm 26, leads to proper segmentation of the aneurysm wall 30 and to accurate rendering in 3D. Indeed, as seen on FIG. 3, if cross-section images were to be defined along the geometric centreline B of the aneurysm lumen 38 for example, two successive cross-section images taken in areas where the lumen 38 is more irregular might intersect at point B1 on one side of the aneurysm outer wall 30. On the opposite side, each cross-section image would intersect the outer wall 30 at points B2 and B3 but the spacing between these points would be large, leading to a loss in precision, as no additional points would have been obtained to more accurately define the region of the outer wall 30 between B2 and B3. Taking cross-section images along the minimum-curvature path A therefore ensures that none of the cross-section images intersect, resulting in a more precise definition of the contour of the aneurysm 26. Illustratively, the minimum-curvature path A is computed by initially extracting a shortest path between the two landmarks L1 and L2. This shortest path is illustratively obtained using Dijkstra's algorithm, an algorithm which solves shortest-path problems for directed graphs. A matrix of discrete point coordinates Dₚ, which correspond to the lowest-cost (i.e. shortest) path between the two landmarks L1 and L2, is then obtained in the Dijkstra metric. The gray-level values Idp (i.e. the brightness) of each discrete point Dₚ are further extracted as Idp=Image (Dₚ), using the 3D image (Image) reconstructed from the acquired slices. These values are then used to compute a Fuzzy representation FuzzyImage of the native (i.e. original) images based on a Gaussian distribution centred at the mean value of the gray-level values Idp as follows:

FuzzyImage=exp(−((Image−mIdp)·̂2)/(k*(StdIdp)̂2)) (1)

with: Image=normalized 3D image
mIdp=mean value of Idp
StdIdp=standard deviation of Idp
k=an integer that controls the width of the Gaussian distribution

Once the Fuzzy images have been computed, a distance-map is illustratively obtained using the fast-Marching algorithm based on the propagation of a wave front starting at landmark point L1. The front propagation is stopped when it reaches landmark point L2 and a distance map, which supplies each point in the image with the distance to the nearest obstacle point (i.e. boundary), is obtained. From this distance map, the minimum-curvature path A between L2 and L1 is computed, illustratively by back propagation from L2 to L1 using an optimization algorithm such as the gradient descent algorithm, in which a local minimum of a function is found by determining successive descent directions and steps from a starting point on the function.

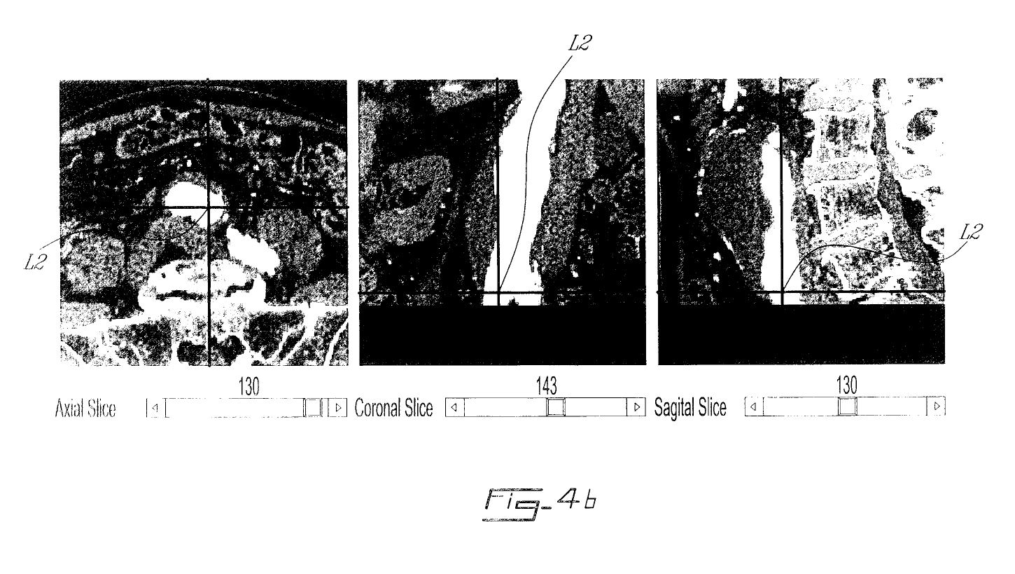

Referring now to FIG. 5 in addition to FIG. 4a, FIG. 4b and FIG. 2, at 108, the minimum-curvature path A is then used to interpolate image slices defined by successive cross-sections along the path A. This will result in a new image space of interpolated cross-section images, on which segmentation of the aneurysm will subsequently be performed. For this purpose, a Frenet reference frame is illustratively defined on the path start point (L1 or L2). A Frenet reference frame is a local coordinate system, which can be calculated anywhere along a curve independently from the curve's parameterization and consists of the tangent vector to the curve, the normal vector that points to the centre of the curve and the binormal vector, which is a cross product of the tangent and normal vectors. For each successive discrete point on the path A, the Frenet reference frame is recomputed and the changes in translation and rotation between the actual and precedent frame are evaluated. The precedent frame is then propagated to the actual position using small local rotations in order to obtain a torsion-free frame. FIG. 5 shows an example of a cross-section image interpolated at a specific position on the path A. The interpolated cross-section images may be spaced along the path A either regularly or with a spacing function defined by the path's curvature. If a spacing function is used, more cross-sections are computed in the path sections having a high curvature, in order to better define the aneurysm, thus leading to more accurate segmentation.

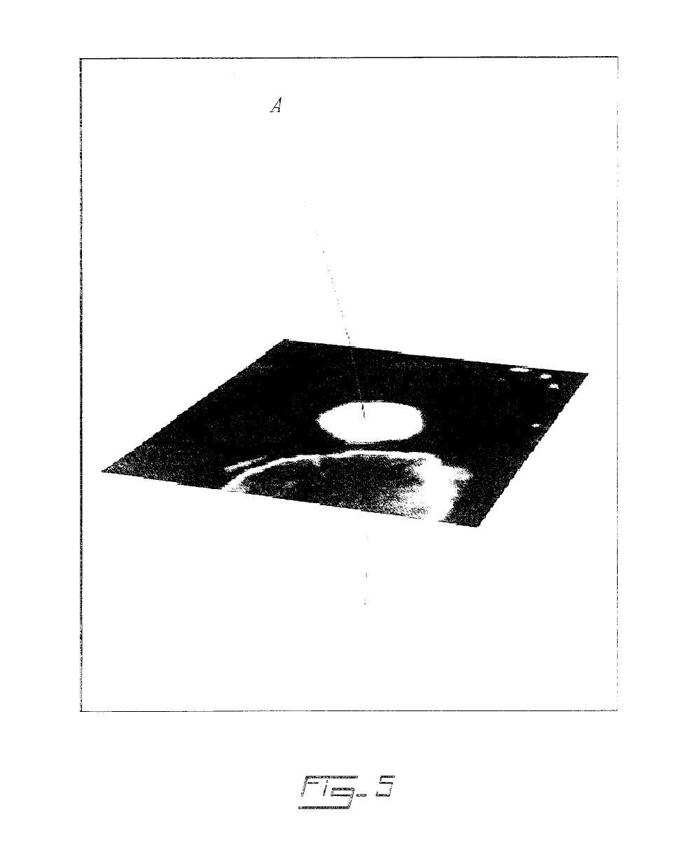

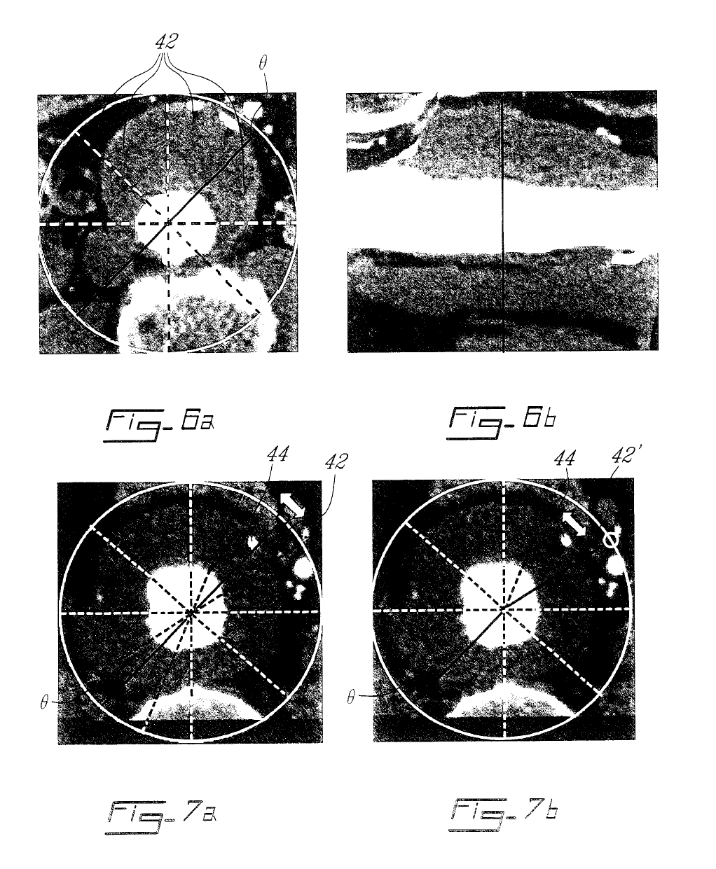

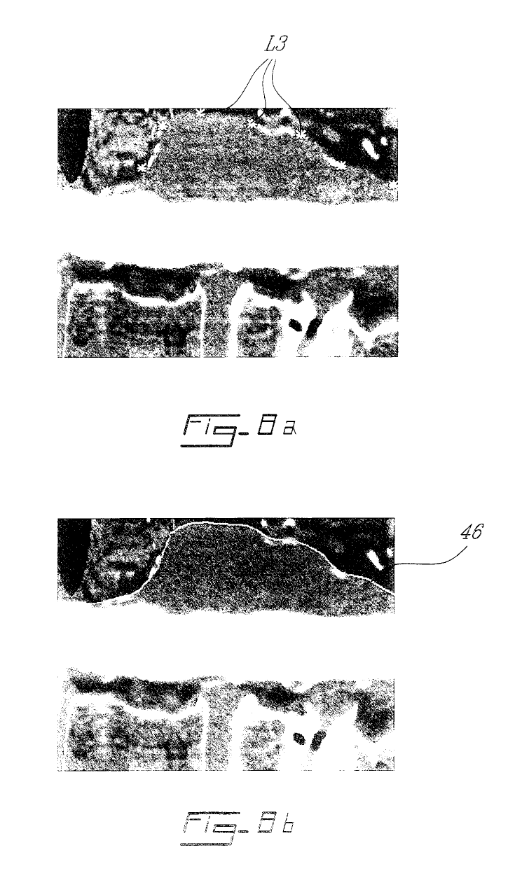

Referring now to FIG. 6a, FIG. 6b, FIG. 7a and FIG. 7b in addition to FIG. 1, FIG. 2 and FIG. 3, using the new image space interpolation, two representations of the cross-section images are illustratively used at 110 to segment the aneurysm wall 30: an axial representation (FIG. 6a) and an image interpolation along the minimum-curvature path A at a specific angular position θ around it (FIG. 6b). Defining angular slices 42 at an angular position θ allows the user to segment the aneurysm wall 30 at a variety of angles 8. Proper selection of the number of slices 42 ensures that the slices 42 pass through certainty areas, i.e. areas of the aneurysm 26 where image information is known, and avoid risk areas (e.g. noise and artifacts) during the segmentation process. The number of angular slices 42 (Nₐₛ) is preferably set to a pre-determined value, which may be interactively modified by the user according to the shape of the aneurysm 26 to be segmented by editing the corresponding input field using the interaction device 24. Nₐₛ is illustratively set by default to four (4) angular slices 42 for aneurysms 26 of generally circular shape but it may be increased for aneurysms 26 with a less regular shape, e.g. when the aneurysm 26 is very off-centre. In the latter case, the number of angular slices 42 is increased to create more cross-sections around the more irregular areas of the aneurysm 26, thereby better defining and more accurately representing it. The value of Nₐₛ defines the spacing step (in degrees) for the angular positioning θ of the slices 42. This spacing step may be computed as follows:

Spacing step=(180)/Nₐₛ (2)

As seen in FIG. 6a for example, Nₐₛ is set to four (4), thereby defining angular slices 42 regularly spaced by a spacing step of 45 degrees. The corresponding angular positions θ of the slices 42 are illustratively then 0, 45, 90, and 135 degrees. The user may further edit the configuration, position, and number of the angular slices 42 (or half-slices 42′), leading to angular slices 42 which are irregularly spaced. Such irregular spacing of the angular slices 42 may be desirable to better define the volume under inspection, especially when the latter is not perfectly circular, in which case more slices 42 should be introduced, as discussed herein above. As shown in FIG. 7a and FIG. 7b, the angular position θ of a slice 42 may be edited with the user interaction device 24 by mouse click and drag, thus changing the position of the selected angular slice 42. In FIG. 7a, in order to avoid an artefact 44, the angular position θ of a full slice 42 is moved while in FIG. 7b only a half-slice 42′ is edited by mouse drag. Similarly, a selected slice 42 (or half-slice) can be removed and new slices (or half-slices) added by mouse click and drag.

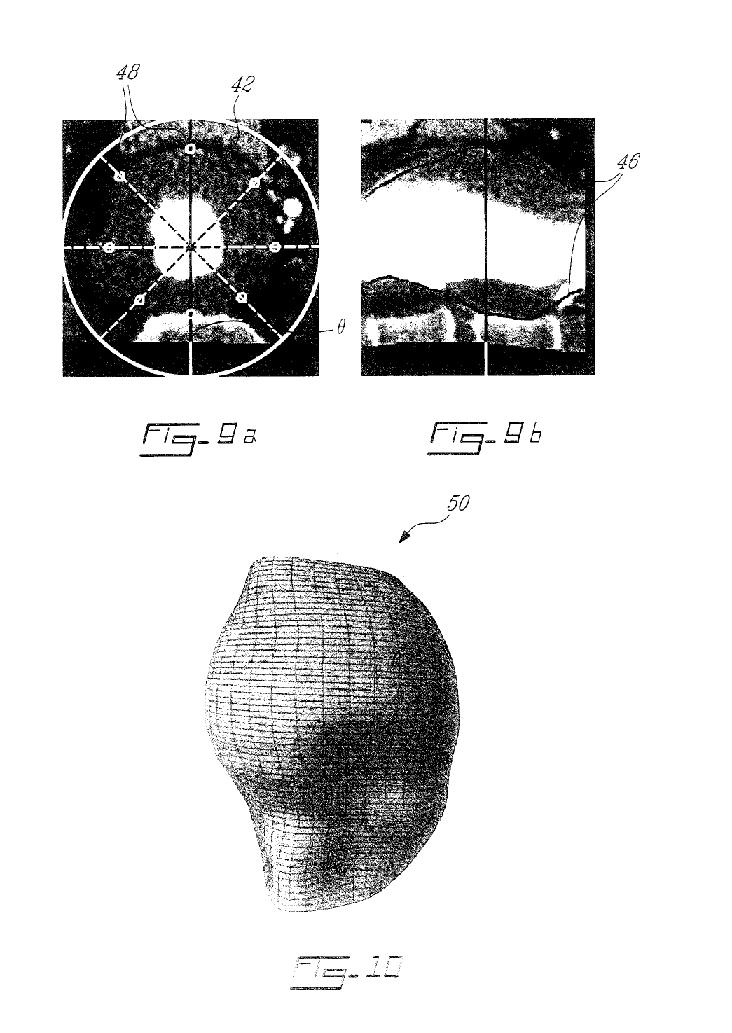

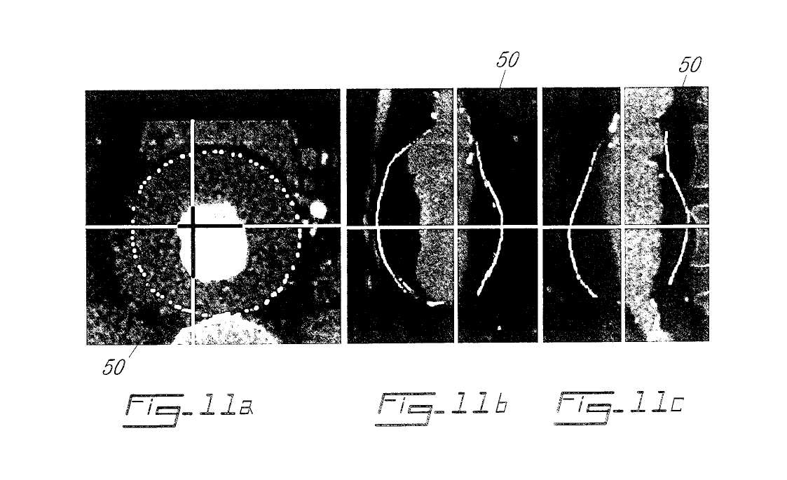

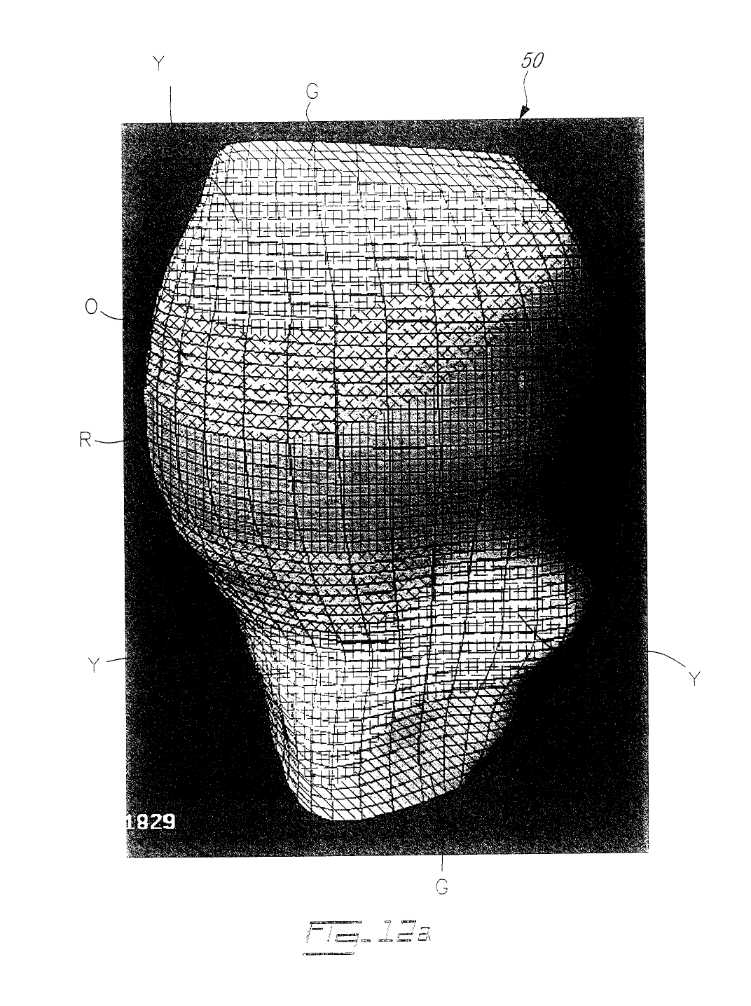

Now referring to FIG. 8a, FIG. 8b, FIG. 9a and FIG. 9b in addition to FIG. 2, FIG. 3 and FIG. 7, once the configuration of the slices 42 has been validated by the user, the latter may proceed with the segmentation (110) of the aneurysm boundaries. For this purpose, the user illustratively uses an active contour method to segment the outer aneurysm wall 30 in the angular slices 42 defined beforehand. This method is an iterative energy-minimizer method, which is based on the rigidity of the deformable contour. Livewire segmentation may also be used as a segmentation method. In this case, regions of interest are extracted based on Dijkstra's algorithm by calculation of a smallest cost path between selected landmarks. Another segmentation approach that can be used is active-shape contour, which specifies the shape of the segmented boundary curve for a particular type of objects a priori, based on statistics of a set of images and measurements of the relevant area. This enables natural inclusion of anatomical knowledge into the segmentation process. Indeed, the borders in a particular anatomical scene are characterized by discrete samples at the contours, with these points being situated at selected landmarks characteristic for every image of the same scene, e.g. typical corners, bays or protrusions, holes, and blood vessel branching. The selection of a set of such landmarks is carried out in preparation of the segmentation procedure. Depending on the image character, the feature points in the typical image may form one or more closed borders surrounding anatomically meaningful means.

As illustrated in FIG. 8a and FIG. 8b, using active-shape contour segmentation, the user interactively places several landmarks L3 (FIG. 8a) near the aneurysm wall 30 by mouse click, thus generating automatic segmentation of the aneurysm boundary 46 (FIG. 8b). The user may further control the quality of the segmentation on the axial view (112). The segmented boundary 46 may be locally edited to correct the position of some points as needed. As illustrated in FIG. 9a, the intersection between the observed axial plane and the segmented aneurysm boundaries 46 is represented by points 48 located on the respective angular slices 42. The user may push or pull a local region on all boundary curves 46 (FIG. 8b) and thus edit the latter using specific mouse-defined functions. After manual deformation, the boundary curves 46 will be automatically optimized by local active contour deformation. Alternatively, the segmentation process may be applied on images illustrated in FIG. 7a and FIG. 7b, such images being substantially perpendicular to the ones illustrated in FIG. 8a and FIG. 8b. In this case, the user similarly initializes the active contour interactively as a closed contour on several slices, the active contour being initialized either by placing successive markers, such as the landmarks mentioned herein above, or by positioning a parametrical model, such as a circle or ellipse, subsequently transformed and optimized in the image space. Still, although active-shape contour has been used as a segmentation approach, it will be apparent to one skilled in the art that other methods, such as parametric and geometric flexible contour algorithms, may be used.

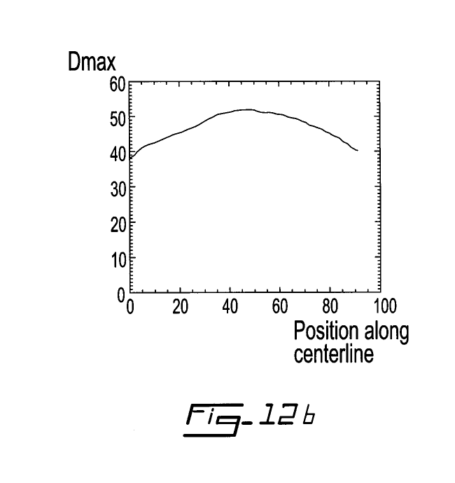

Referring now to FIG. 10, FIG. 11a, FIG. 11b and FIG. 11a in addition to FIG. 2 and FIG. 3, following quality control and correction at 112, a 3D parametric surface representation 50 of the aneurysm wall 30 is automatically computed at 114 (although one skilled in the art would recognize that other visualization techniques are possible). This 3D surface mesh model 50 (illustrated in FIG. 10) is then back-projected in the initial image space (i.e. the native DICOM images), resliced and represented in axial (FIG. 11a), sagittal (FIG. 11b) and coronal (FIG. 11c) views. From the 3D wall model 50, it is then possible to proceed with quantification of the aneurysm parameters (116). At this point, the geometrical centreline (represented by the dashed line associated with reference B in FIG. 3) of the aneurysm 26, which passes through the centre of the aneurysm 26 and whose points are all at equidistance from the aneurysm wall 30, is computed. This geometrical centreline B, which differs from the minimum-curvature path A described herein above and used to define cross-sections, is used to compute the value of the maximum diameter Dₘₐₓ of the aneurysm 26. Indeed, upon extraction of the centreline B, the 3D wall model 50 is automatically resliced by cross-section planes defined along this new centreline B. The maximal distance between all points on the 3D wall model 50 is then computed in each centreline-defined cross-section, illustratively using the following pseudo-code:

All_Pts = matrix(M,N,3)
for j=1, N do begin

X = All_Pts(*,j,1)
Y = All_Pts(*,j,2)
Z = All_Pts(*,j,3)
for i=1, M do begin

diam = max(sqrt(((x[i]−x))\hat{ }2 +((y[i]−y))\hat{ }2 +((z[i]−z))\hat{ }2))
aThrombusALLMaxDiameters[j,i] = diam

endfor

endfor
with All_Pts = matrix of all data points on the parametric 3D model;

diam = maximum diameter mapped at a given point of the 3D model.

The final matrix aThrombusALLMaxDiameters holds the value of Dₘₐₓ for each point of the 3D aneurysm wall model 50. Similarly, other attributes or components of the aneurysm 26, such as the thickness of the thrombus 40, lumen 38, wall 30, calcifications and plaque (not shown), can be measured in order to monitor changes over time.

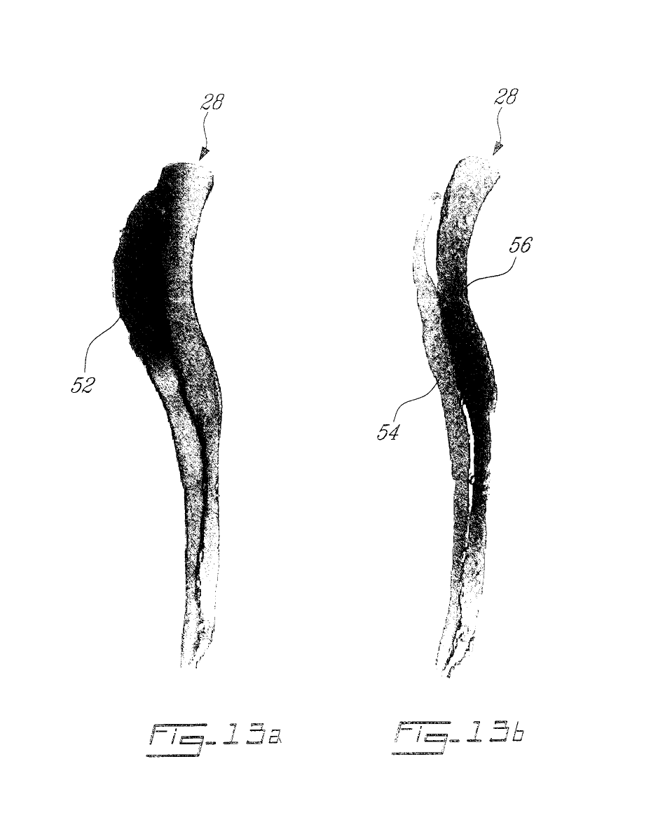

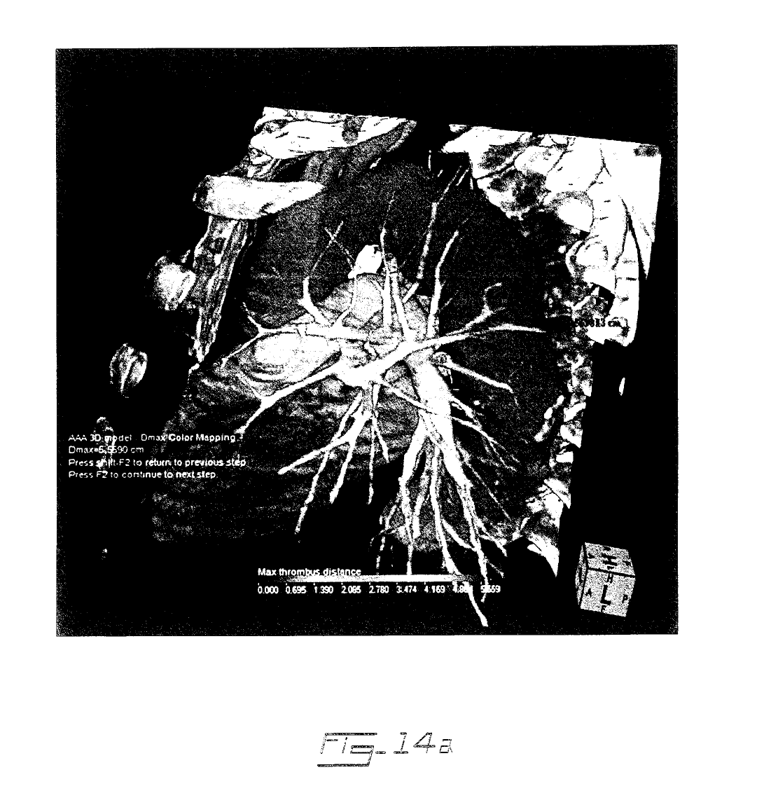

Referring now to FIG. 12a and FIG. 12b in addition to FIG. 2 and FIG. 3, in order to provide clear information regarding the local parameter values of the aneurysm 26, the 3D surface wall model 50 is augmented with a coding, such as colour-coding, shading, hatching, or the like. A combination of hatching, colour and letter coding (with B for blue, C for cyan, G for green, Y for yellow, O for orange and R for red) is shown in FIG. 12a for illustrative purposes only, although a person of skill in the art will appreciate that any other suitable coding may be used to represent the measured parameters. Illustratively, the Dₘₐₓ value is mapped on the 3D model 50 using a colour scale, for example one which varies from blue to red or the like to represent increasing values of Dₘₐₓ. Alternatively, Dₘₐₓ may be represented for each cross-section along the centreline B, as shown in FIG. 12b. This representation advantageously shows the Dₘₐₓ profile along the centreline B in a two-dimensional (2D) curve. The maximal value on the curve is therefore the sought global value of Dₘₐₓ, which can be used as a diagnostic measure of the aneurysm 26. For a patient having undergone two clinical imaging exams at times t1 and t2, and thus for two respective image sets IS₁ and IS₂, two values Dₘₐₓ₁ and Dₘₐₓ₂ of the maximal diameter are computed for each image set. The change in the maximal diameter of the aneurysm 26 over time is then computed as the difference between Dₘₐₓ₁ and Dₘₐₓ₂. At 118, once the aneurysm parameters have been quantified, the results are stored in the database 12 for subsequent review. This allows patient monitoring and follow up by enabling the study of the expansion rate of the Dₘₐₓ parameter (and similarly other attributes of the aneurysm 26 mentioned herein above) in the long run.

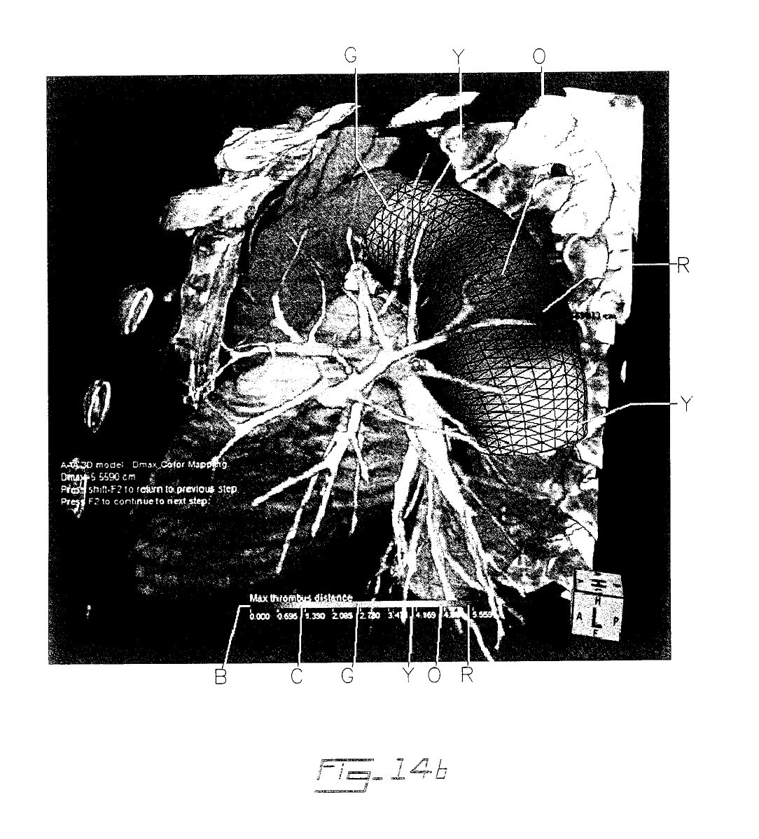

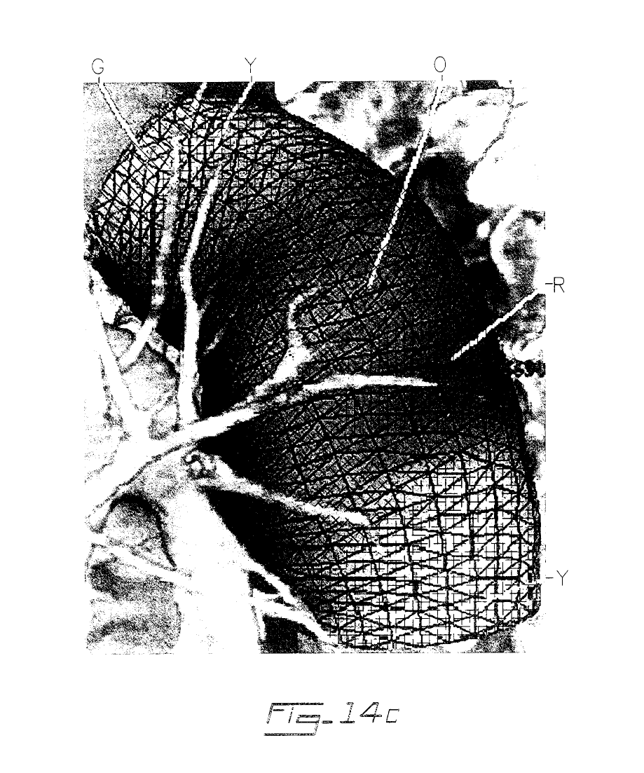

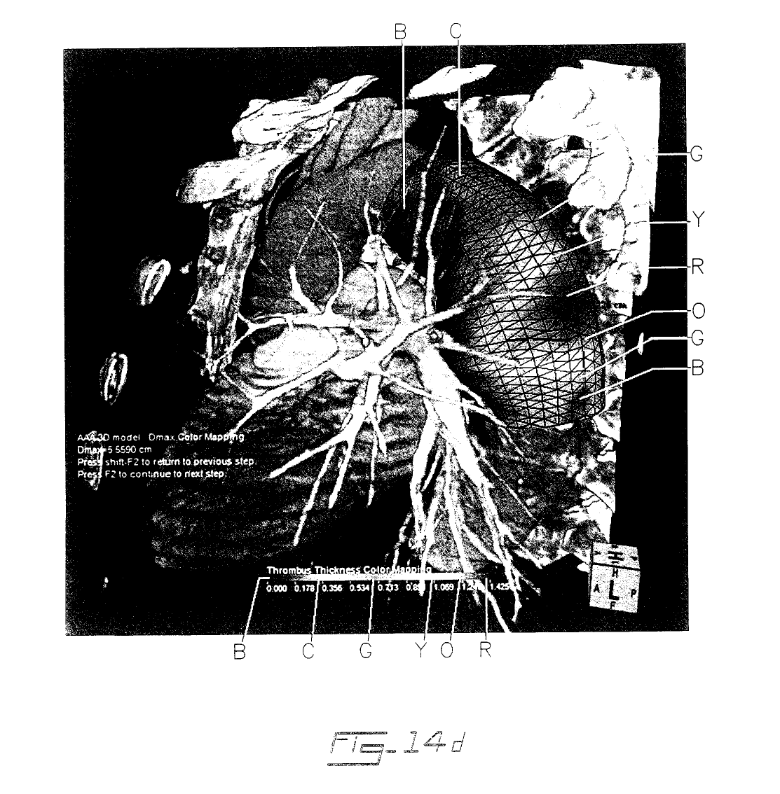

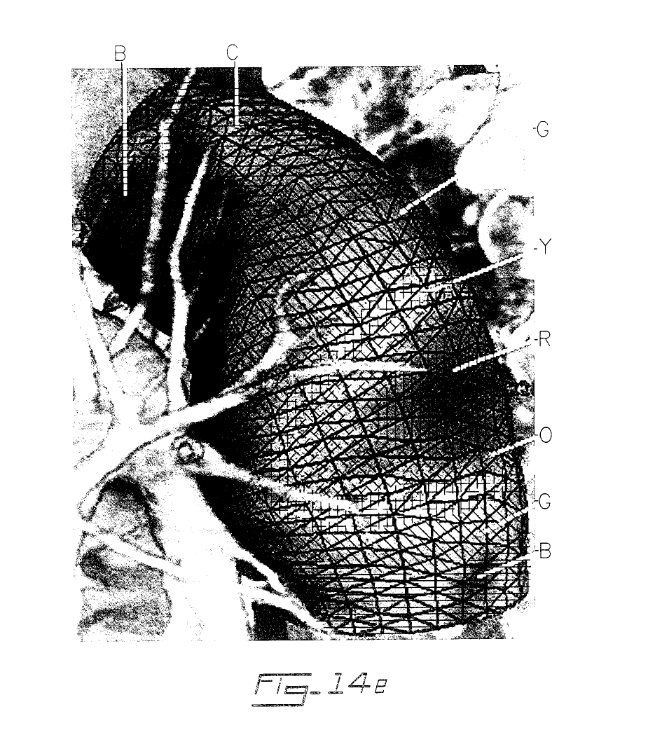

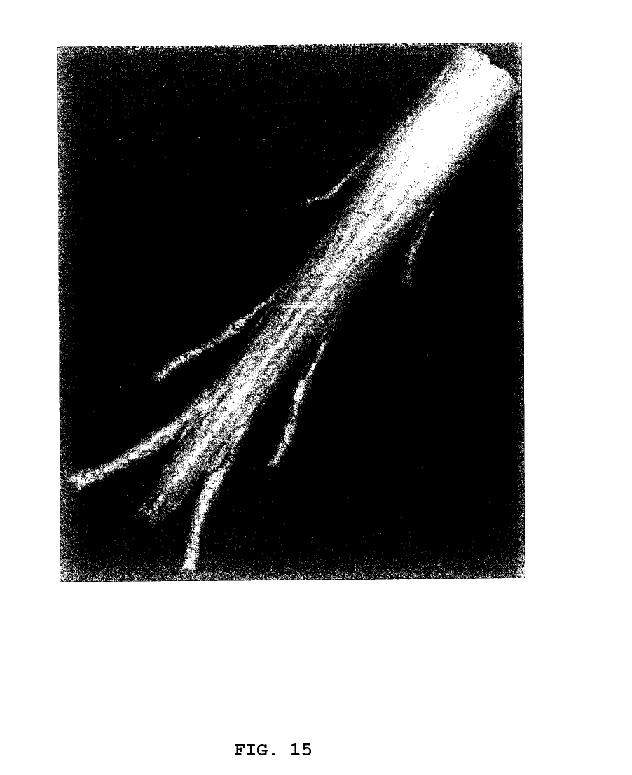

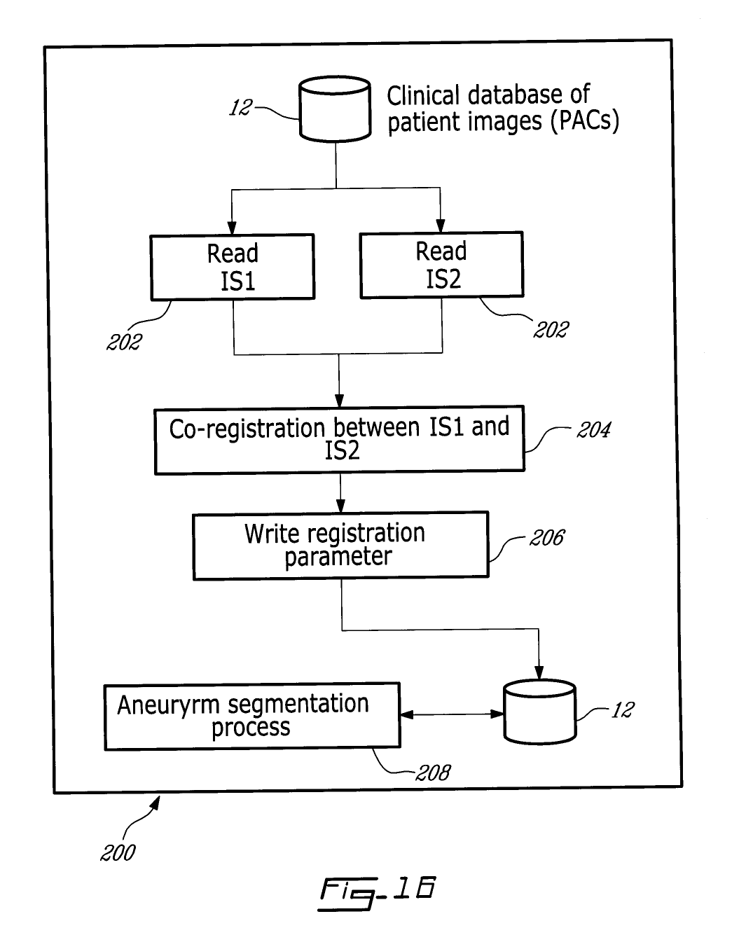

Referring now to FIG. 13a, FIG. 13b, FIG. 14a, FIG. 14b, FIG. 14c, FIG. 14d, FIG. 14e, and FIG. 15, the present invention can be used for a plurality of applications. For example, the segmentation method illustratively allows to distinguish the volume of the false thrombus 52 (FIG. 13a), i.e. the abnormal channel within the wall of the aorta 28, from the volume of the pathological components 54 and 56 (FIG. 13b) of the aorta lumen (reference 38 in FIG. 3), which are due to aortic dissection, a tear in the wall of the aorta 28 that causes blood to flow between the layers of the aortic wall and to force the layers apart. In this case, the aorta 28 is illustratively automatically segmented from the aortic arch to the iliac bifurcation (both not shown). Also, as mentioned previously, the segmentation process described herein above can be applied to anatomical structures other than abdominal aortic aneurysms, such as thoracic aortic aneurysms for example. This is illustrated in FIG. 14a, which, in the case of a thoracic aortic aneurysm, shows the segmentation of the aorta lumen 38. FIG. 14b and FIG. 14c further show the segmentation of the thrombus (reference 40 in FIG. 3) and the mapping of the Dₘₐₓ value on the 3D model (reference 50 in FIG. 10) using coding, illustratively hatching, although it will be apparent to a person skilled in the art that a colour scale or the like could be used without departing from the scope of the present invention, as discussed herein above with reference to FIG. 12a and FIG. 12b. Similarly, FIG. 14d and FIG. 14e illustrate the segmentation of the thrombus 40 and the mapping of the thrombus thickness on the 3D model 50 using a suitable coding. Moreover, FIG. 15 illustrates the application of the method of the present invention for segmentation of a cat's spinal cord (not shown).

When two or more sets of image data from one region are acquired at different times, using different imaging modalities, or for different patient orientations, it is desirable for them to be co-registered before segmentation. This will ensure that corresponding image features are substantially identically positioned in the matrices of image data and thus spatially consistent. Indeed, the imaging geometry for each of the images may be different due to possibly different physical properties and distortions inherent to different modalities. Also, the imaged scene itself may change between taking individual images due to patient movements, and/or physiological or pathological deformations of soft tissues. Ideally, a particular point in each of the registered images would correspond to the same unique spatial position in the imaged object, e.g. a patient. Registration thus transforms the images geometrically, in order to compensate for the distortions and fulfil the consistency condition. Typically, one of the images, which may be considered undistorted, is taken as the reference (base) image. The process of registration illustratively uses a geometrical transformation controlled by a parameter vector that transforms one image into a transformed image, which is then laid on (i.e. spatially identified with) the other (base) image so that both images can be compared. A degree of accuracy and precision is required when registering medical images as imprecise registration leads to a loss of resolution or to artefacts in the combined (fused) images, while unreliable and possibly false registration may cause misinterpretation of the fused image (or of the information obtained by fusion), with possibly fatal consequences.

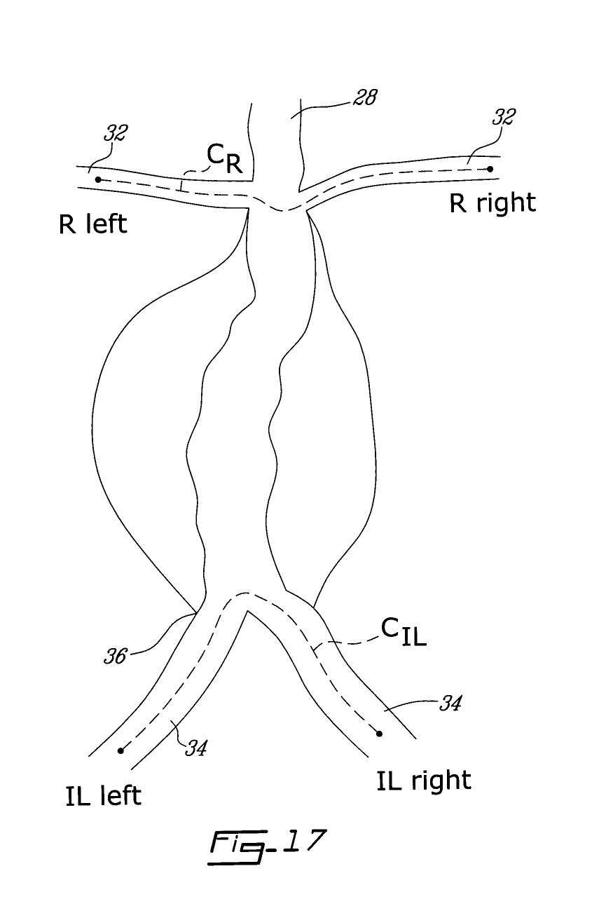

Referring now to FIG. 16 and FIG. 17 in addition to FIG. 1, an image registration method 200 according to the present invention will now be described. In order to co-register two image sets IS₁ and IS₂ (acquired for the same patient at times t1 and t2), which have been read by the imaging software 20 at 202, four vascular landmarks are initialized in each image set (204). This can be done, for example as illustrated in FIG. 17 (for a single image set), by a user defining (preferably in MPR view) two landmarks, R_{left} and R_{right}, in the left and right renal arteries 32 respectively and two other landmarks, IL_{left} and IL_{right}, in the left and right iliac arteries 34 respectively, after the bifurcation 36 of the aorta 28. After landmark initialization, vascular centreline-paths are extracted from the landmarks. Illustratively, a first vessel centreline-path, the renal path C_{R}, is computed from R_{right} to R_{left} while a second vessel centreline-path, the iliac path C_{IL}, is computed from IL_{right} to IL_{Left}. Similarly to 106 described herein above with reference to FIG. 2, these centreline paths C_{R} and C_{IL} are obtained illustratively using the Dijkstra shortest path algorithm on the images smoothed by a Gaussian filter. The vessel curves thus obtained are represented as ordered discrete points defined in the image coordinate system. As will now be apparent to a person of skill in the art, more than two such vessel curves may be extracted from the initialized landmarks R_{right}, R_{left}, IL_{right} and IL_{left}, resulting in more accurate registration of the image sets IS₁, and IS₂. For example, two additional centreline paths may be computed from R_{left} to IL_{right} and R_{right} to IL_{left} respectively.

Still referring to FIG. 16 and FIG. 17 in addition to FIG. 1, the similarity criteria between the renal paths C_{R} and iliac paths C_{IL} extracted from each image set IS₁, and IS₂ are then identified. Similarity criteria, which serve to evaluate the resemblance of two (and possibly more) images or their areas, must be evaluated when matching two or more images via geometrical transformations, as is the case of image registration. For this purpose, it is desirable to use a method independent of location, rotation and scale. The curve signature of each centreline path C_{R} and C_{IL} can thus be represented by its local tangent, curvature and torsion. More specifically, the curve arc-length is illustratively normalized and the curve signature is computed, followed by signature correlation between the two renal paths C_{R} and the two iliac paths C_{IL}. Point to point association is then achieved by maximum correlation detection, thus leading to 3D registration between paired points. As a result, an affine transformation matrix with three (3) rotation and three (3) translation parameters is illustratively obtained. These registration parameters are stored in the database 12 at 206 and the transformation is applied to one of the image sets, i.e. either IS₁, or IS₂, in order to co-register it with the other image set.

The above registration process may be further improved using an image-based processes such as mutual information algorithms. Mutual information, which proves to be a good criterion of similarity, is defined as the difference between the sum of information in individual images and the joint information in the union. Use of the mutual information algorithm results in masking the image sets by a weighted function that enables an image volume element (voxel) near the centreline and disables the others, thus showing how much the a priori information content of one image is changed by obtaining the knowledge of the other image.

Referring now to FIG. 2 and FIG. 3 in addition to FIG. 16, following co-registration of the image sets IS₁ and IS₂, the segmentation process (208) may proceed as described above, with a minimum-curvature path A being extracted in a similar manner as in 106. However, since the images have been co-registered before they are segmented, the segmentation algorithm will use the pair of co-registered image sets together to ensure that the extracted minimum-curvature path is defined inside both lumens of the two superimposed image sets. The results obtained with co-registered images are more efficient since the real changes in volume, surface, and thickness may be illustratively computed and mapped in 3D, as the two image sets IS₁ and IS₂ are superimposed in the same geometrical reference frame. Moreover, local and global changes in geometry and topology of the aneurysm may be obtained for the two image sets.

As will now be apparent to one skilled in the art, the approach described herein is efficient whether contrast agents have been used or not. Contrast agents are not used during all clinical imaging exams, as it is preferable to avoid their use in some cases, such as when the patient under observation is suffering from renal failure. If no contrast agent has been used, although the lumen 38 (FIG. 3) will potentially have the same gray level distribution as the thrombus 40, it is still possible to quantify the maximum diameter as well as the aneurysm volume using the method described herein above. More importantly, the diagnostic tool of the present invention achieves fast and accurate results with a high level of reproducibility. The segmentation may therefore be performed in a standardized manner by technicians, thus leading to time savings for doctors and other clinicians who only need to be involved in the subsequent review processes.

Although the present invention has been described hereinabove by way of specific embodiments thereof, it can be modified, without departing from the spirit and nature of the subject invention as defined in the appended claims.

1. A method for visualizing an anatomy of a region of interest of a tubular-shaped organ on a display, the method comprising:
acquiring an image of the anatomy of the tubular shaped organ in the region of interest at a first point in time;
extracting a plurality of discrete points from said image defining a minimum-curvature path within the tubular-shaped organ;
interpolating a set of cross-sectional images along planes substantially perpendicular to a tangent vector of said minimum-curvature path at each of said plurality of discrete points;
delimiting a segmented area corresponding to the region of interest of the tubular-shaped organ in each of said set of cross-sectional images;
rendering a three-dimensional surface representation of the region of interest from said delimited set of cross-sectional images; and
displaying said rendered three-dimensional surface representation on the display.

2. The method of claim 1, wherein said image is comprised of a plurality of image slices.

3. The method of claim 1, wherein the tubular-shaped organ has a longitudinal axis and further wherein said acquiring successive image slices comprises obtaining each one of said image slices along a plane substantially perpendicular to said longitudinal axis.

4. The method of claim 1, wherein said acquiring successive image slices comprises using an image modality selected from the group consisting of Computed Tomography angiography and Magnetic Resonance Imaging angiography.

5. The method of claim 2, further comprising positioning at least two reference markers in said image slices, wherein said minimum-curvature path connects said reference markers.

6. The method of claim 5, wherein said positioning reference markers in said image slices is performed in Multi-Planar Reformatting (MPR) view.

7. The method of claim 1, wherein the tubular-shaped organ is selected from the group consisting of an aorta, a colon, a trachea, and a spine.

8. The method of claim 5, wherein said extracting a plurality of discrete points comprises:
obtaining a plurality of discrete point coordinates defining a lowest-cost path between said reference markers using Dijkstra's algorithm;
deriving gray-level values of each one of said plurality of discrete point coordinates;
computing from said derived gray-level values fuzzy image representations of said acquired image slices;
computing a distance map representative of a distance from a discrete point in each one of said fuzzy image representations to an adjacent obstacle point in said one fuzzy image representation; and
computing said minimum-curvature path from said distance map.

9. The method of claim 8, wherein said reference markers comprise a first reference marker and a second reference marker.

10. The method of claim 9, wherein said computing a distance map comprises applying a fast-marching algorithm based on propagation of a wave front from said first reference marker to said second reference marker.

11. The method of claim 10, wherein said minimum-curvature path is computed from said distance map by applying back propagation from said second reference marker to said first reference marker using an optimization algorithm.

12. The method of claim 11, wherein said optimization algorithm is a gradient descent algorithm.

13. The method of claim 5, wherein said interpolating cross-sectional images comprises defining a Frenet reference frame at a first one of said reference markers, and, for a successive one of said discrete points along said minimum-curvature path, recomputing said Frenet reference frame and propagating said recomputed Frenet reference frame to said successive one of said discrete points.

14. The method of claim 1, wherein said segmented area is delimited in an axial representation and in an angular representation of each of said cross-sectional images.

15. The method of claim 14, wherein said angular representation comprises a plurality of angular slices of each of said cross-sectional images acquired at a plurality of angles around said minimum-curvature path.

16. The method of claim 15, wherein a positioning and a number of said angular slices is selected to accurately define the region of interest.

17. The method of claim 1, wherein said delimiting a segmented area is performed using a method selected from a group consisting of active-shape contour segmentation, parametric flexible contour segmentation, geometric flexible contour segmentation, and livewire segmentation.

18. The method of claim 1, further comprising quantifying an attribute of the region of interest from said three-dimensional surface representation and augmenting said three-dimensional surface representation with a coding representative of said attribute.

19. The method of claim 18, wherein said coding is selected from a group consisting of colour, shading and hatching or combinations thereof.

20. The method of claim 18, wherein said attribute of the region of interest is selected from a group consisting of maximal diameter and volume.

21. The method of claim 20, wherein quantifying said maximal diameter of the region of interest comprises:
computing a geometrical centreline of the region of interest;
slicing said three-dimensional surface representation by cross-section planes defined along said geometrical centreline to generate a plurality of centreline-defined cross-sections; and
computing a maximal distance between discrete points in each one of said plurality of centreline-defined cross-sections.

22. The method of claim 18, wherein said quantifying an attribute of the region of interest comprises:
acquiring a second image of the anatomy of the tubular shaped organ in the region of interest at a second point in time;
extracting a second plurality of discrete points from said second image slices, said second points defining a minimum-curvature path within the tubular-shaped organ;
interpolating a second set of cross-sectional images along planes substantially perpendicular to a tangent vector of said minimum-curvature path at each of said second plurality of discrete points;
delimiting a segmented area corresponding to the region of interest of the tubular-shaped organ in each of said second set of cross-sectional images;
rendering a second three-dimensional surface representation of the region of interest from said delimited second set of cross-sectional images;
calculating a difference between said three-dimensional surface representation and said second three-dimensional surface representation; and
augmenting said three-dimensional surface representation with a coding representative of said difference.

23. A method for visualizing the anatomy of a region of interest of a tubular-shaped organ, the method comprising:
acquiring at least a first image and a second image of the anatomy of the tubular shaped organ in the region of interest, said first image and said second image having different imaging geometries;
computing similarity criteria between said first image and said second image;
deriving at least one geometrical transformation parameter from said similarity criteria;
co-registering said first image and said second image according to said at least one geometrical transformation parameter;
extracting a plurality of discrete points from said co-registered first and second images, said points defining a minimum-curvature path within the tubular-shaped organ;
interpolating cross-sectional images from said co-registered first and second images along planes substantially perpendicular to a tangent vector of said minimum-curvature path at said plurality of discrete points;
delimiting a segmented area corresponding to the region of interest of the tubular-shaped organ in each of said cross-sectional images;
computing a three-dimensional surface representation of the region of interest from said segmented area; and
quantifying attributes of the region of interest from said three-dimensional surface representation.

24. The method of claim 23, wherein said first image and said second image are in a DICOM format.

25. The method of claim 23, wherein said first image is comprised of a first set of image slices and said second image is comprised of a second set of image slices.

26. The method of claim 23, wherein said first image and said second image are acquired at different times.

27. The method of claim 23, wherein said first image and said second image are acquired using different imaging modalities.

28. The method of claim 23, wherein said first image and said second image are acquired for different orientations of a patient being monitored.

29. The method of claim 23, wherein said computing similarity criteria between said first image and said second image comprises:
positioning a first set of reference markers in said first image and a second set of reference markers said second image;
extracting a first centreline path connecting said first set of reference markers and a second centreline path connecting said second set of reference markers; and
computing similarity criteria between said first centreline path and said second centreline path.

30. The method of claim 23, wherein said similarity criteria is computed using a mutual information algorithm.

31. The method of claim 29, further comprising positioning a third set of reference markers in said co-registered first and second images, and further wherein said minimum-curvature path connects said third set of reference markers.

32. The method of claim 23, further comprising implementing the method at a first point in time and at a second point in time, thereby quantifying said attributes at said first point in time and at said second point in time, and computing a difference between said attributes quantified at said second point in time and said attributes quantified at said first point in time for monitoring changes in the anatomy of the region of interest over time.

33. A system for visualizing the anatomy of a region of interest of a tubular-shaped organ, the system comprising:
a scanning device for acquiring an image of the region of interest of the tubular shaped organ;
a database connected to said scanning device for storing said acquired image; and
a workstation connected to said database for retrieving said stored image, said workstation comprising:
a display;
a user interface; and
an image processor;
wherein responsive to said commands from said user interface, said image processor extracts from said image a plurality of discrete points defining a minimum-curvature path within the region of interest of the tubular-shaped organ, interpolates a set of cross-sectional images along planes substantially perpendicular to a tangent vector of said minimum-curvature path at each of said plurality of discrete points, delimits a segmented area corresponding to the region of interest of the tubular-shaped organ in each of said set of cross-sectional images, computes a three-dimensional surface representation of the region of interest from said delimited set of cross-sectional images and displays said computed three-dimensional surface representation on said display.

34. A computer program storage medium readable by a computing system and encoding a computer program of instructions for executing a computer process for visualizing the anatomy of a region of interest of a tubular-shaped organ, the computer process comprising:
acquiring an image of the anatomy of the tubular shaped organ in the region of interest;
extracting from said image a plurality of discrete points defining a minimum-curvature path within the tubular-shaped organ;
interpolating a set of cross-sectional images along planes substantially perpendicular to a tangent vector of said minimum-curvature path at each of said discrete points;
delimiting a segmented area corresponding to the region of interest of the tubular-shaped organ in each of said set of cross-sectional images;
computing a three-dimensional surface representation of the region of interest from said delimited set of cross-sectional images; and
displaying said rendered three-dimensional surface representation on the display.
